(19) United States
(12) Patent Application Publication
(10) Pub. No.: US 2019/0342754 A1
(43) Pub. Date: Nov. 7, 2019

(54) LOCATION BASED AUTHENTICATION

(71) Applicant: WATCH OUT!, INC., Del Mar, CA (US)

(72) Inventors: Michael T. Lucas, Del Mar, CA (US); Patrick Nunally, Escondido, CA (US)

(21) Appl. No.: 16/397,810

(22) Filed: Apr. 29, 2019

Related U.S. Application Data
(60) Provisional application No. 62/664,192, filed on Apr. 29, 2018.

(51) Int. Cl. H04W 12/06; H04W 4/02; H04W 4/021; H04L 12/26; H04W 4/029

(52) U.S. Cl. CPC H04W 12/06; H04W 4/023; H04W 4/029; H04L 43/0864; H04W 4/021

(57) ABSTRACT

Systems and methods for location based authentication are disclosed wherein the location of an electronic device associated with a recipient, sender, or both are used to authenticate the identity of a user or authenticity of a document, where the location of the electronic device may be verified using a round-trip time calculated through a switched network, through a breadcrumb location history, or a combination thereof.

### CROSS REFERENCE TO RELATED APPLICATIONS

This claims priority to U.S. Prov. Pat. App. No. 62/664,192 filed on Apr. 29, 2018, the entirety of which is hereby incorporated by reference.

### BACKGROUND OF THE INVENTION

Field of the invention: This invention relates to the general field of authentication, and more specifically toward systems and methods for location based authentication.

There continues to be a plague of identity theft and financial card fraud that has been estimated by some to be costing merchants billions of dollars each year. Various prior art systems and methods have been utilized to combat this fraud without success.

However, it is extremely difficult, if not impossible, to be in two places at the same time. In other words, no two individuals can occupy the same physical location at the same time. Accordingly, a location can be used to authenticate the identity of an individual or object.

Thus there has existed a long-felt need for systems and methods to authenticate the identity of an individual or the source of an object such as an electronic document.

### SUMMARY OF THE INVENTION

The current invention provides just such a solution by having systems and methods for location based authentication disclosed wherein the location of an electronic device associated with a recipient, sender, or both are used to authenticate the identity of a user or authenticity of a document, where the location of the electronic device may be verified using a round-trip time calculated through a switched network, through a breadcrumb location history, or a combination thereof.

It is an object of the disclosure to provide a system for authenticating the identity of an individual by confirming the location of the individual.

It is another object of the current disclosure to provide a system for authenticating the identity of an individual by tracking the history of locations of an individual.

It is a further object of this disclosure to provide a method for authenticating the identity of an individual by confirming the location of the individual.

It is an additional object of the current disclosure to provide a method for authenticating the identity of an individual by tracking the history of locations of an individual.

According to selected embodiments of the current disclosure, a remote system reads in an identifier from a nearby mobile device. The remote system then transmits the identifier of the mobile device as well as an identifier of the remote system to a server system. The location of the remote system is known to the server system. The server system, using the identifier of the mobile device, then sends a request to the mobile device requesting its location. The mobile device sends a response to the server system that includes data indicating the mobile device's location. The server system then determines whether the location of the mobile device match's or is otherwise sufficiently similar to the remote system, and if so, returns a response to the remote system indicating that the identifier of the mobile device is authentic, and if not, returns a response to the remote system indicating that the identifier of the mobile device is not authentic.

Further embodiments of the current disclosure include a mobile device that transmits data indicating its location along with its unique identifier to a server system on a regular basis, that is, based upon a time or location change. The server system tracks and stores the indicated location of the mobile device. A remote system reads in the identifier from the nearby mobile device. The remote system then transmits the identifier of the mobile device as well as an identifier of the remote system to a server system. The location of the remote system is known to the server system. The server system, using the identifier of the mobile device, then retrieves the stored location(s) of the mobile device. The server system then determines whether the current location of the mobile device match's or is otherwise sufficiently similar to the remote system, and if so, returns a response to the remote system indicating that the identifier of the mobile device is authentic, and if not, returns a response to the remote system indicating that the identifier of the mobile device is not authentic.

Embodiments of the current disclosure also include validating the location indicated by a mobile device by determining the round-trip time of a network request to and from the server system and an electronic device, and determining whether the round trip-time validates the location indicated by the electronic device. More specifically, the server system may request the location of the electronic device, receive a response that includes data indicating the location of the electronic device, and determine the time from when the request was made until the response was received. This time can be correlated to a distance from the server system. Such a request and response can be made multiple times to determine the most appropriate round-trip time of a network request and to more accurately determine the distance from the server system to the electronic device. Moreover, multiple different server systems in different geographic locations may be utilized to increase the accuracy of the location indicated by the round-trip time of the switched network request.

Additional embodiments of the current disclosure include preparing, creating, identifying, generating or otherwise selecting an electronic document on an electronic device and associating the electronic document with one or more recipients. Each recipient is associated with one or more geographic locations, that is, one or more geo-fenced physical spaces. The electronic document is encrypted using a token, and the document is transmitted to the one or more recipients. The token and recipient identifiers are transmitted to a server system. The electronic document may only be opened (decrypted) at the one or more geographic locations associated with the recipient. More specifically, the recipient may request the token from the server system by sending a request to the server system that includes the recipient identifier and the recipient's location. The location is validated by matching it to one or more previously identified geo-fenced locations associated with the recipient. Upon validation, the token is transmitted to the recipient, which is used to decrypt the document.

Other embodiments of the current disclosure include preparing, creating, identifying, generating or otherwise selecting an electronic document on an electronic device and associating the electronic document with a unique identifier of the electronic device as well as data indicating its location. The document is then transmitted to a recipient. The recipient then transmits the unique identifier of the electronic device as well as data indicating its location. The server system then requests the location of the electronic device, and the electronic device transmits data indicating its location to the server system. The server then compares the location provided by the electronic device with the location indicated in the document and if matching or otherwise sufficiently similar, provides a response to the recipient that the document is authentic.

Further embodiments of the current disclosure include preparing, creating, identifying, generating or otherwise selecting an electronic document on an electronic device and associating the electronic document with a recipient, unique identifier of the electronic device as well as data indicating its location. The document is then transmitted to a server system. The server system then requests the location of the electronic device, and the electronic device transmits data indicating its location to the server system. The server then compares the location provided by the electronic device with the location indicated in the document and if matching or otherwise sufficiently similar, transmits the document to the recipient. Optionally, the server may associate additional data with the document indicating that it has been authenticated by the server system.

In yet other embodiments of the current disclosure, an electronic document is received by a recipient electronic device, where the electronic document is associated with a location in which it may be viewed, listed to, or otherwise consumed. The recipient electronic device transmits a response back to a server system that includes a unique identifier of the recipient. The server system then requests the location from the recipient electronic device, and the recipient electronic device returns data indicating its location. The server system then compares the location associated with the electronic document with the location indicated by the recipient electronic device and if they match or are sufficiently similar, transmits a confirmation of receipt to a sender of the electronic device.

Additional embodiments of the current disclosure include a recipient electronic device that requests any available documents from a server system. The server system then requests the location of the recipient electronic device, which in turn responds with data indicating its location. The server system then selects the available electronic documents for the recipient where the location of the recipient matches or is sufficiently similar to a location associated with each respective document, and then the selected electronic documents are transmitted to the recipient electronic device.

Further embodiments of the current disclosure include preparing, creating, identifying, generating or otherwise selecting an electronic document on a first electronic device whose location is known and fixed. The electronic document is associated with a unique identifier of the first electronic device as well as a user identifier of a user who prepared, created, identified, generated, or otherwise selected the electronic document. The electronic document along with its associated data is transmitted to a server system. The server system then requests the location of a second electronic device, where the second electronic device is associated with the user identifier. The second electronic device then returns data indicating its location. The server system then compares the location of the first electronic device with that of the second electronic device, and if they match or are sufficiently similar, authenticates that the user prepared, created, identified, generated, or otherwise selected the electronic document.

In yet other embodiments of the current disclosure, there includes a mobile device associated with a particular user. The mobile device transmits data indicating its location to a server system at intervals determined by time and/or distance criteria. The server system stores this location data and utilizes the data to authenticate the identity of the individual. The criteria of transmission/provision of location data is determined by elliptical boundaries, time elapsed, or a combination thereof. This provides for sufficiently accurate location paths with minimal data, which as the benefit of not only reduced electronic storage requirements, but also faster processing of authentications.

It should be appreciated that the various embodiments disclosed herein are not necessarily mutually exclusive, and may each be used in conjunction with other embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future. Furthermore, the use of plurals can also refer to the singular, including without limitation when a term refers to one or more of a particular item; likewise, the use of a singular term can also include the plural, unless the context dictates otherwise.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

As used herein, mobile device or mobile electronic device, shall mean and refer to mobile electronic computing systems that may change location from time to time during or between uses, including without limitation, mobile phones, tablet computers, laptop computers, networked connected watches, networked connected glasses, mobile payment card readers, vehicles, aircraft, and vessels.

There has thus been outlined, rather broadly, the more important features of the invention in order that the detailed description thereof may be better understood, and in order that the present contribution to the art may be better appreciated. There are additional features of the invention that will be described hereinafter and which will also form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a graphical representation of a two dimensional network plane showing links and distances between networked devices.

FIG. 2 is a map with a t and corresponding ellipse according to selected embodiments of the current disclosure.

FIG. 3 is a map showing a series of t's corresponding to the path of a user according to selected embodiments of the current disclosure.

FIG. 4 shows a map with t areas and corresponding ellipses for a path of a user according to selected embodiments of the current disclosure.

FIG. 5 is a flow chart showing a method or protocol for authorizing account access according to selected embodiments of the current disclosure.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

Location data, or data representing the location of a mobile computing device such as a mobile phone, can be a powerful tool in identifying and authenticating an individual. However, if the location data is falsified or otherwise incorrect, the value of the location data for identifying or authenticating an individual decreases. Certain methods disclosed herein teach validation of a data source, that is validation of location data, via networked communications. The validation of a physical location represented by location data of a data source may be accomplished by determining a round-trip time (RTT) and comparing that to the expected time based upon the distance to the location identified in the data payload of the location data.

A round-trip time, also called round-trip delay, is the time required for a signal pulse or packet to travel from a specific course to a specific destination, and back again. In this context, the source is the system initiating the request (signal) (for example, a server system) and the destination is the remote computer or system (for example, the mobile device) that receives the request and retransmits it back to the system initiating the request. The minimum round-trip time (minRTT) is the sum of the propagation delay through the network and extra delay due to extra circular routes. For example, on the internet, an end user can determine the round-trip time to and from and internet protocol (IP) address by pinging that address. The result may depend on various factors, including the path through the network and network loads, and may be defined generally by Equation 1:

ΔT=Δt+Δt₀ Equation 1

where ΔT is the actual round trip time, Δt is the propagation delay, and Δt₀ is the extra delay causing overestimation. Actual distance between the two devices can be represented as a proportional offset of the actual propagation delay along the paths:

D=Δt·α Equation 2

where D is the actual distance and a is the speed through the network. A pseudo distance (ρD) represents a proportional offset of the minimum round-trip time:

ρD=αminRTT Equation 3

ρD=α(Δt+Δt₀) Equation 4

ρD=α(Δt)+α(Δt₀) Equation 5

ρD=D+α(Δt₀) Equation 6

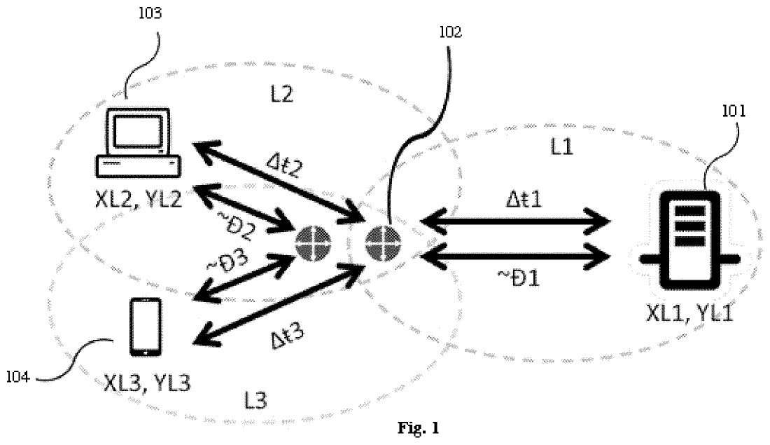

FIG. 1 is a graphical representation of a two dimensional network plane showing links and distances between networked devices. Server 101 has a first communication link L1 with a router 102, which then has a second communication link L2 with remote computer system 103 and a third communication link L3 with mobile system 104. From this, we can differentiate from the computer server:

D1=\sqrt{(XL1−Xh)²+(YL1−Yh)²} Equation 7

From equations 6 and 7:

ρD1=\sqrt{(XL1−Xh)²+(YL1−Yh)²}+α(Δt₀) Equation 8

ρD2=\sqrt{(XL2−Xh)²+(YL2−Yh)²}+α(Δt₀) Equation 9

ρD3=(XL3−Xh)²+(YL3−Yh)²+α(Δt₀) Equation 10

A Taylor series is applied to linearize Equations 8, 9, and 10:

$$\begin{matrix}{\sum }_{n = 0} \frac{{f}^{( n )} ( a ) {( x - a )}^{n}}{n !} & Equation 11 \\ f ( x ) = f ( {x}_{0} ) + \frac{f ( {x}_{0} ) ( x - {x}_{0} )}{1 !} + \frac{f ( {x}_{0} ) ( x - {x}_{0} )}{2 !} & Equation 12\end{matrix}$$

Considering the first simplified first part of Equation 12:

f(x)=f(x₀)+f(x₀)(x−x₀) Equation 13

Let x−x₀=Δx:

f(x)=f(x₀)+(x₀)Δx Equation 14

To compute the original value of X, an arbitrary value of x₀ is required. It is known that:

Hₓ=Xₑₛₜ+ΔX Equation 15

H_{y}=Yₑₛₜ+ΔY Equation 16

estDᵢ=(Hₓ−Xₑₛₜ)²+(H_{y}−Yₑₛₜ)² Equation 17

### From Equations 14 and 17:

$$ρ {D}_{i} = {estD}_{i} + \frac{d ( {estD}_{i} ) Δ X}{dX} + \frac{d ( {estD}_{i} ) Δ Y}{dY} + α ( Δ {t}_{0} ) \qquad Equation 18$$

### Differentiate Equation 18:

$$ρ {D}_{i} = {estD}_{i} + \frac{( {X}_{est} - {X}_{h} )}{dX} ( Δ X ) + \frac{( {Y}_{est} - {Y}_{h} )}{dY} ( Δ Y ) + α ( Δ {t}_{0} ) \qquad Equation 19$$

### Solving for ΔX, ΔY and ΔT:

$$[ \begin{matrix}ρ {D}_{i} - {estD}_{i} \\ ρ {D}_{2} - {estD}_{2} \\ ρ {D}_{3} - {estD}_{3}\end{matrix} ] = [ \begin{matrix}\frac{( {X}_{est} - {X}_{L 1} ) ( {Y}_{est} - {Y}_{L 1} )}{{estD}_{i} {estD}_{i}} \\ \frac{( {X}_{est} - {X}_{L 2} ) ( {Y}_{est} - {Y}_{L 2} )}{{estD}_{2} {estD}_{2}} \\ \frac{( {X}_{est} - {X}_{L 3} ) ( {Y}_{est} - {Y}_{L 3} )}{{estD}_{3} {estD}_{3}}\end{matrix} ] X [ \begin{matrix}Δ X \\ Δ Y \\ Δ T\end{matrix} ] \qquad Equation 20$$

The solutions are then inserted into Equations 15 and 16 to get new estimations, that is, Hx and Hy become the new estimations. Over sample time, Hx and Hy will converge and offsets will be used to cross correlate location metrics.

As discussed herein, exemplary embodiments teach validating the location of a mobile device from a computer or server system. Nonetheless, the same methods and apparatus for validating locations may be implemented between fixed computer systems, between mobile computer systems with known locations. For example, a computer server at a fixed location may validate the location of another computer server at a fixed location as an additional measure to authenticate their communications. Likewise, a mobile device may validate the location of another mobile device to authenticate their communications.

As may be appreciated to one skilled in the art, the accuracy of the validation of location data provided by a mobile device may increase with a larger number of samples of round-trip time. In addition to identifying the current location of a mobile device, and thus of a mobile device user, it may be advantageous to track the user's geographic history, that is, where the user has been and when. Such location histories, however, can require large resources, both in computation of validating resources and data storage of the histories. Thus, it is beneficial to have a system and method for tracking the location or geographic history of a user using a smaller data set.

Certain embodiments of the current disclosure provide using a smaller data set to store the location history of a user. A cross or lower case “t” provides a frame for an ellipse that bounds a geographic area in which the user is or was located. The t's or ellipses are linked together to form a “breadcrumb” to track not only the location history, but the path history of a user without relying upon periodic points of location.

The width of the “t” grows in relation to its height, but the width does not necessarily scale at the same rate as the height. The smaller the fractional relationship between the height and the width, the more accurate the tracking. However, the more accurate the tracking, the greater the data set of “breadcrumbs” or t's to track the user. The width of the t may also need a maximum limit to offset long distance travel anomalies. Periodic time endpoints may also be used, wherein if a breadcrumb has not been set for more than a set period of time, a new breadcrumb or t is created and stored to identify any smaller order changes and track time at a set position.

For example, a system and method are used to track a user with a small data set, accepting some nominal error and utilizing a lower computational burden. The longitude and latitude are used as inputs, and a sample rate and fractional relationship are set as parameters. Multiple samples are collected, each triggered because no new breadcrumb has been required for a set period of time. In other words, the same longitude and latitude is provided multiple times in a row indicating the user is stationary at a first location.

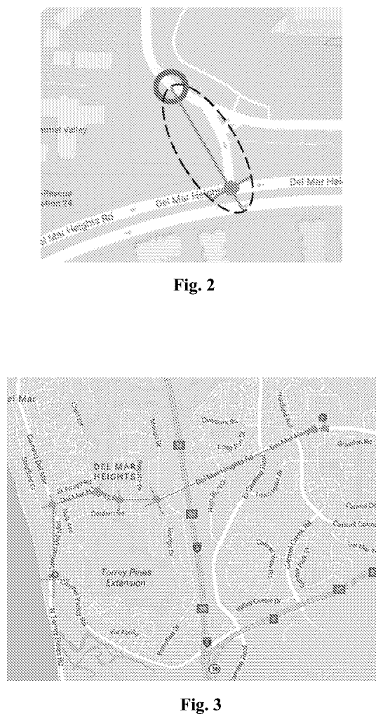

At some point, the user leaves the first location. FIG. 2 is a map with a t and corresponding ellipse according to selected embodiments of the current disclosure. When the user moves outside of the area enclosed by the corresponding ellipse of the t, a new breadcrumb is dropped at the cross of the t, or the foci of the ellipse. As the user continues on, the breadcrumb is used as the point of origin, and a new t is utilized to indicate the area within which the user is located.

FIG. 3 is a map showing a series of t's corresponding to the path of a user according to selected embodiments of the current disclosure. The end point of a particular trip at a second location is not determined by exiting a t area (ellipse defined by the t), but rather is triggered by no change in position for more than a set period of time. Accordingly, in this case, rather than using hundreds or thousands of data points to describe a user's movement from a first location to a second location, less than ten data points may describe approximately the same route.

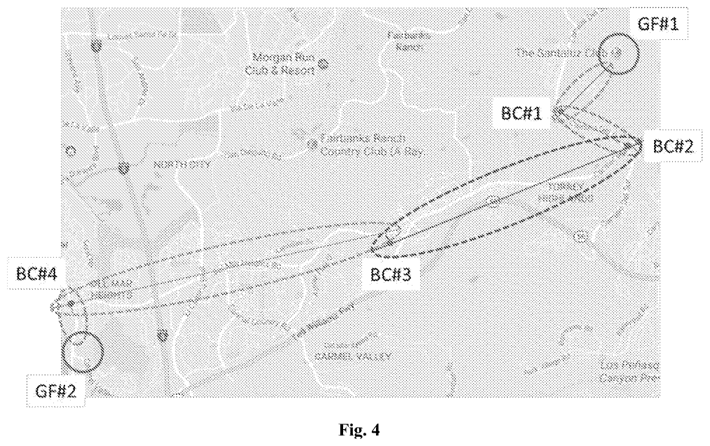

To define the t areas and path of the user more rigorously, using polar coordinates in the Euclidean plan of origin (p) and target (q), let p=(r₁,θ₁) and 1=(r₂,θ₂) so that the major axis of an ellipse is expressed. FIG. 4 shows a map with t areas and corresponding ellipses for a path of a user according to selected embodiments of the current disclosure. BC refers to a breadcrumb point, and GF refers to an endpoint of a particular trip.

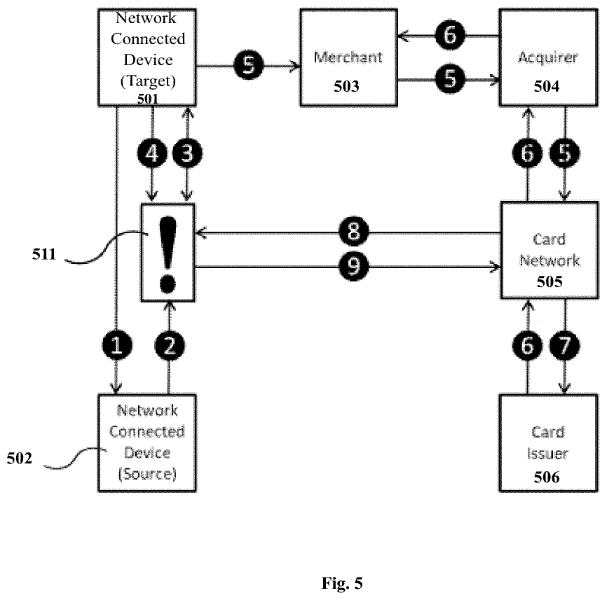

FIG. 5 is a flow chart showing a method or protocol for authorizing account access according to selected embodiments of the current disclosure. A network connected device 501, that is a target device such as a server system, requests account access 1 from another networked connected device 502, that is a source device such as a mobile device of a user. The request for account access 1 might be, for example, to withdraw or deposit funds, to gain access or to input health data, or otherwise providing or reading sensitive data regarding the user. Upon receipt of the request for account access 1, a user can accept or decline, and upon acceptance, grants access with token and permissions with dynamic cryptogram 2 to the authentication system 511. The granting of access 2 results in a verification or push application interacting with the network connected device 501 to obtain an ID chain, which passed along with the token back to the network connected device for processing. The token is used for obtaining permission to access an account of the user with dynamic cryptogram 5, which is passed to the merchant 503, then to the acquirer 504, and then to the card network 505. The card network 505 passes the token used for account access 8 to the authentication system 511, which returns the account number or other sensitive data 9 to the card network 505. The card network sends an approval query 7 to the card issuer 506 who sends back an approval or decline 6. The approval or decline 6 is then passed on back to the acquirer 504 and then to the merchant 503 to proceed accordingly. In this manner, restricted access to sensitive information may be provided to select entities or applications, without having account numbers or other higher level information passed through the merchant or target networked connected device. The authentication system 511 may utilize validation of geographic location and/or location histories to authenticate the various entities involved in the transfer of data as disclosed in various embodiments herein.

While various embodiments of the present invention have been described above, it should be understood that they have been presented by way of example only, and not of limitation. Likewise, the various diagrams may depict an example architectural or other configuration for the invention, which is provided to aid in understanding the features and functionality that can be included in the invention. The invention is not restricted to the illustrated example architectures or configurations, but the desired features can be implemented using a variety of alternative architectures and configurations.

Indeed, it will be apparent to one of skill in the art how alternative functional configurations can be implemented to implement the desired features of the present invention. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

What I claim is:

1. A system comprising one or more processors executing programming logic, the programming logic configured to:
receive a request for authentication of a user of a device, where the request for authentication comprises a user identifier;
identify a device associated with the user identifier;
send a location request to the device and in response to the location request, receive data indicating a location of the device;
determine a round-trip time to receive data indicating the location of the device,
determine a pseudo distance utilizing the round-trip time;
determine a degree of correlation between the pseudo distance and the indicated location.

2. The system of claim 1, wherein the programming logic is further configured to determine whether the location indicated by the received data is within the boundaries of a physical space defined by one or more data sets.

3. The system of claim 1, wherein the round-trip time comprises a propagation delay through a switched network.

4. The system of claim 1, wherein the programming logic configured to determine a degree of correlation between the pseudo distance and the indicated location comprises determining whether the pseudo distance is within an acceptable range of an expected distance to the indicated location.

5. The system of claim 1, wherein the programming logic is further configured to
send a second request to the device and in response to the second request, receive second response data;
determine a second round-trip time to receive the second response data,
determine a second pseudo distance utilizing the second round-trip time;
determine a degree of correlation between the second pseudo distance and the indicated location.

6. The system of claim 5, wherein the second response data does not indicate the location of the device.

7. The system of claim 1, wherein the request for authentication comprises authentication location data.

8. The system of claim 7, wherein the authentication location data comprises a geographic boundary data set, where the geographic boundary data set indicates the boundaries of a physical space associated with an authentication location.

9. The system of claim 8, wherein the programming logic is further configured to determine whether the indicated location is within the boundaries of the physical space indicated by the geographic boundary data.

10. The system of claim 1, wherein the programming logic is further configured to store the location of the device.

11. The system of claim 1, wherein the programming logic is further configured to
send a plurality of secondary requests to the device and in response to the plurality of secondary requests, receive a plurality of secondary response data;
determine a plurality of secondary round-trip times to receive the plurality of secondary response data;
determine a secondary pseudo distance utilizing the plurality of secondary round-trip times;
determine a degree of correlation between the secondary pseudo distance and the indicated location.

12. The system of claim 1, wherein the programming logic is further configured to
receive data indicating a second location of the device;
send a second request to the device and in response to the second request, receive second response data;
determine a second round-trip time to receive the second response data,
determine a second pseudo distance utilizing the second round-trip time;
determine a degree of correlation between the second pseudo distance and the indicated second location.

13. A non-transitory computer-readable medium, comprising instructions stored thereon, that when executed on one or more processors, perform the steps of:
receiving a request for authentication of a user of a device, where the request for authentication comprises a user identifier;
identifying a device associated with the user identifier;
sending a location request to the device through a switched network and in response to the location request, receive data indicating a location of the device;
determining a round-trip time to receive data indicating the location of the device,
determining a range of expected round trip times through the switched network utilizing the indicated location;
determining whether the round-trip time falls within the range of the expected round trip times.

14. The non-transitory computer-readable medium of claim 13, wherein the instructions further comprise the step of determining whether the indicated location is within the boundaries of a physical space defined by one or more data sets.

15. The non-transitory computer-readable medium of claim 13, wherein the round-trip time comprises a propagation delay through the switched network.

16. The non-transitory computer-readable medium of claim 13, wherein the request for authentication comprises authentication location data.

17. The non-transitory computer-readable medium of claim 16, wherein the authentication location data comprises a geographic boundary data set, where the geographic boundary data set indicates the boundaries of a physical space associated with an authentication location.

18. The non-transitory computer-readable medium of claim 17, wherein the instructions further comprise the step of determining whether the indicated location is within the boundaries of the physical space indicated by the geographic boundary data.

19. The non-transitory computer-readable medium of claim 13, wherein the instructions further comprise the step of storing the location of the device.

20. A method of authenticating a user comprising the steps of
receiving a request for authentication of a user of a device, where the request for authentication comprises a user identifier;
identifying a device associated with the user identifier;
receiving location data indicating the location of the device;
sending a plurality of requests to the device and in response to the plurality of secondary requests, receive a plurality of responses;
determining a plurality of round-trip times to receive the plurality of responses; determining a pseudo distance utilizing the plurality of round-trip times; and
determining a degree of correlation between the pseudo distance and the indicated location;
whereby a user is authenticated if the degree of correlation is greater than a minimum threshold value.
